(19) United States
(12) Patent Application Publication
(10) Pub. No.: US 2002/0166884 A1
(43) Pub. Date: Nov. 14, 2002

(54) Power stapler

(75) Inventor: Zhen Yu Luo, Tsing Yi (CN)

Correspondence Address: ALIX YALE & RISTAS LLP, 750 MAIN STREET, SUITE 1400, HARTFORD, CT, 06103, US

(73) Assignee: MING SUN ENTERPRISES ( CHINA) LTD.

(21) Appl. No.: 09/852,954

(22) Filed: May 10, 2001

(51) Int. Cl. B25C 5/02

(52) U.S. Cl. 227/131

(57) ABSTRACT

A power stapler which includes a housing, a staple anvil supported by the internal side wall, a staple carriage for feeding an associated cartridge of staples having a plurality of staples in aligned side-by-side relationship towards the staple anvil to position one of the staples in the cartridge above the staple anvil in position to be driven through a plurality of associated sheets held above the staple anvil and a punch plate mounted for sliding movement substantially in a plane that is substantially perpendicular to the staple anvil.

The power stapler further preferably includes an elongated intermediately pivoted lever having a first end disposed in meshing engagement with the punch plate whereby pivotal motion of the lever presses down and lifts up the punch plate to carry out stapling operations, the lever having a cam surface. A gear mounted for rotation about axis thereof has a crank extending from a side thereof. The crank Is disposed in meshing engagement with said cam surface to cause said lever to pivot upon rotation of said gear. The stapler further includes an electric motor coupled to intermittently drive the gear through a series of discrete angular movements corresponding to each stapling operation.

### BACKGROUND OF THE INVENTION

The invention relates to staplers and particularly to power staplers that do not require manual operation and more particularly to a power stapler that does not require manual operation.

Staplers are commonly used in offices and homes for stapling together sheets of paper but may be used for stapling together other items such as textile pieces and the like. In each case the ‘sheets’ are placed on an anvil and a stapler pressed closed. This typically forces a staple from an end of a cartridge of staples through the sheets disposed on the anvil, and closes the staple to attach the sheets together. Such staplers are often manually operated.

Electrically powered staplers have been proposed in U.S. Pat. Nos. 6,068,173 and 5,222,645. The patents essentially show the mechanism of a manual stapler construction that is mechanised by using force generated by an electric battery operated motor mounted inside the stapler. Thus, mechanical limitations associated with manual staplers are not overcome although such ‘power staplers’ provide some inherent improvements and convenience by making the stapling operation at least semi-automatic.

### SUMMARY OF THE INVENTION

It is an object of the invention to provide a power stapler that overcomes or at least reduces these problems.

According to the invention there is provided a battery powered stapler having a housing incorporating a stapler carriage for feeding a cartridge of staplers towards a stapling station where one of the staples in the cartridge is positioned for being driven through a number of sheets held in the station above a horizontal stapler anvil. A punch plate is supported for sliding movement above the anvil in substantially perpendicular relationship to the anvil. An elongated intermediately pivoted lever at one end is arranged to press down and lift up the punch plate to carry out stapling operations. A rotatable gear has a crank that pushes the lever to move the other end of the lever up and down as the gear rotates. The apparatus also includes an electric motor coupled to intermittently drive the gear through a single revolution or some other predefined angular movement for each stapling operation.

The lever preferably has an elongated closed channel to receive the crank such that the crank can slide backwards and forwards along the channel as the gear rotates to move the lever up and down during each stapling operation.

The channel is preferably non-uniformly or asymmetrically disposed about the longitudinal axis of the elongated lever such that the cutting blade is moved up and down at different linear motion rates relative to a constant rotational speed of the gear.

A staple extractor tool may be provided that is mounted for sliding movement to a base of the housing and arranged to be manually moved and exposed at one end of the housing when required for use.

In some forms of the invention the apparatus is battery powered.

### BRIEF DESCRIPTION OF THE DRAWINGS

The invention will be better understood by reference to the accompanying drawings in which:

FIG. 1 is a front isometric external view of the stapler;

FIG. 2 is an interior isometric view, partially exploded, of the mechanism of the stapler;

FIG. 3 is a detailed, enlarged, rear isometric view of the stapler;

FIG. 4 is a diagrammatic front view of the basic components of the stapler showing the lever and punch plate in a first position;

FIG. 5 is a diagrammatic front view of the basic components of the stapler showing the lever and punch plate in a second position; and

FIG. 6 is a diagrammatic front view of the basic components of the stapler showing the lever and punch plate in a third position.

### DESCRIPTION OF THE PREFERRED EMBODIMENT

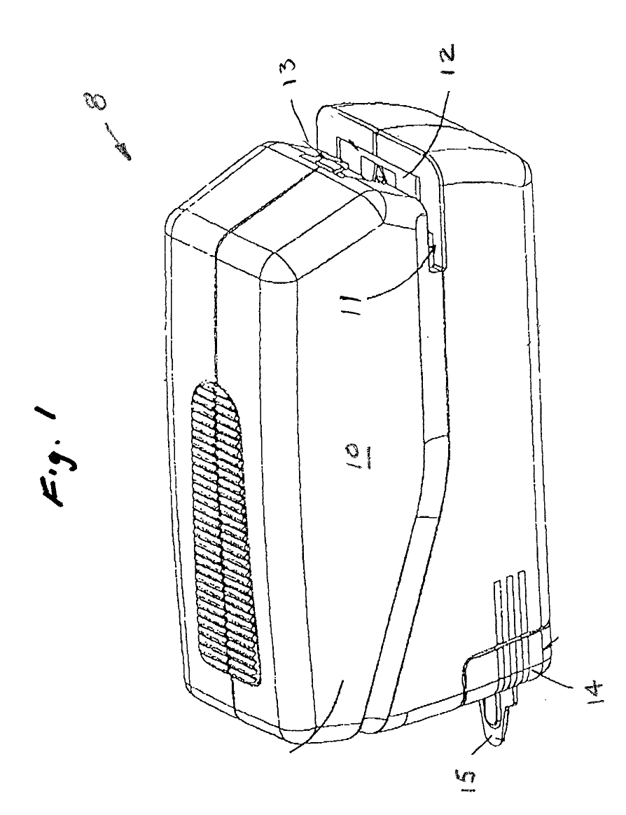

Referring to FIGS. 1-6, there is shown a power stapler 8 having an outer housing 10 which defines a slot 11 for receiving the edges of sheets of paper (not shown) to be stapled together. The power stapler 8 includes a stapling station having a horizontal anvil 12 and an elongated staple cartridge carrier 13. The carrier 13 is mounted for sliding axial movement out of the housing 10 when it is necessary to replace the staple cartridge. A removable battery compartment cover 14 provides access to replace batteries in a compartment that extends within the base of the housing 10. A staple removal tool 15 is mounted for sliding movement in or under the base 10 and is mounted to allow manual movement from a position on or under the base 10 to an extended position, as shown, when required for use.

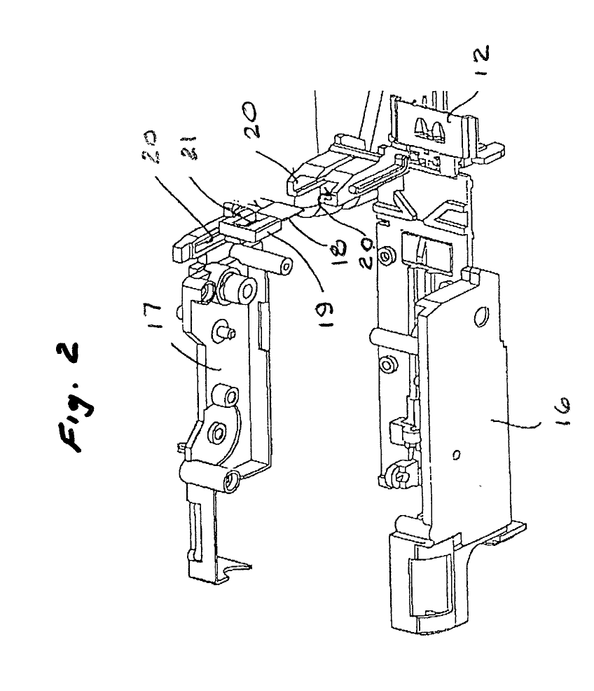

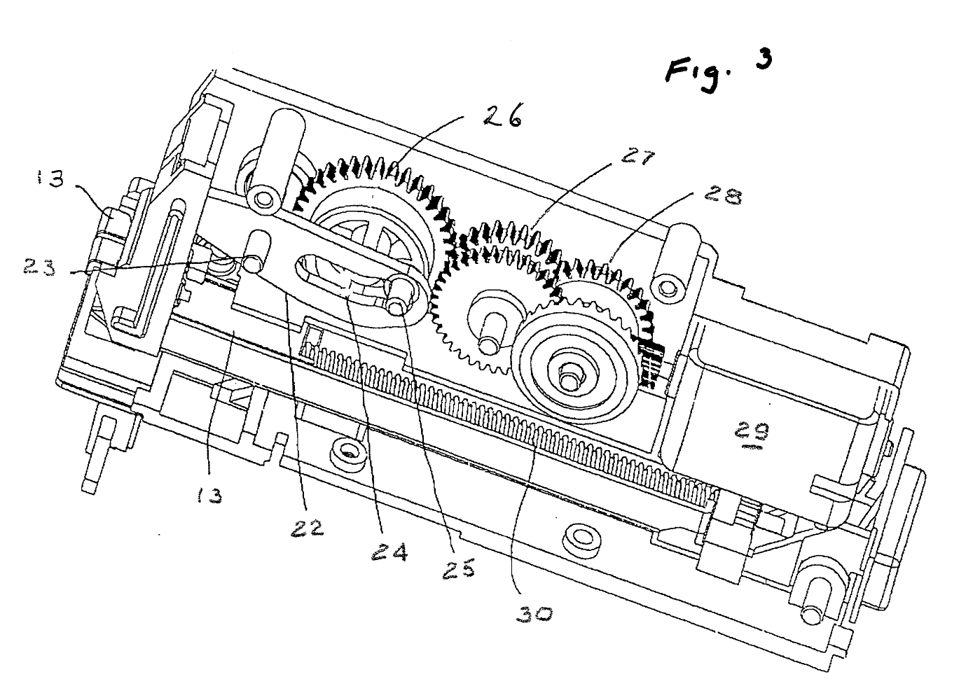

As best seen in FIG. 2, there are two moulded inner side walls 16 and 17 that fit into the housing 10 for supporting and containing components of the stapler described below. A punch blade or punch plate 18 is carried by a support 19. The punch plate or punch blade 18 with the support 19 is arranged to slide vertically within vertical grooves 20. The support 19 has a central aperture 21 for receiving an end of an elongated lever 22 that is best seen in FIG. 3. The lever 22 has a pivot axle 23 and an elongated closed channel 24 for receiving a crank pin 25. The crank pin is mounted on the side of a gear 26, which is rotatable in a vertical plane. Intermediate gears 27 and 28 connect the gear 26 to an electric drive motor 29. FIG. 3 also shows the staple cartridge carrier 13 and a spring 30 for biasing staples (not shown) in the stapler cartridge carrier 13 towards the stapling station.

In general, the well-known stapling operation comprises pressing one staple in the carrier 13 downwards through sheets of paper placed in the stapling station (i.e. in the slot 11) and against the anvil 12 to close the staple. Commonly, stapling operations are performed manually but in embodiments of the invention, stapling operating are carried out by using a ‘single-shot’ electric switch (not shown) to turn ON the motor 29 to rotate the gear 26 one complete revolution. The switch is automatically operated by a momentary switch (not shown) when the sheets are pushed fully into the slot 11.

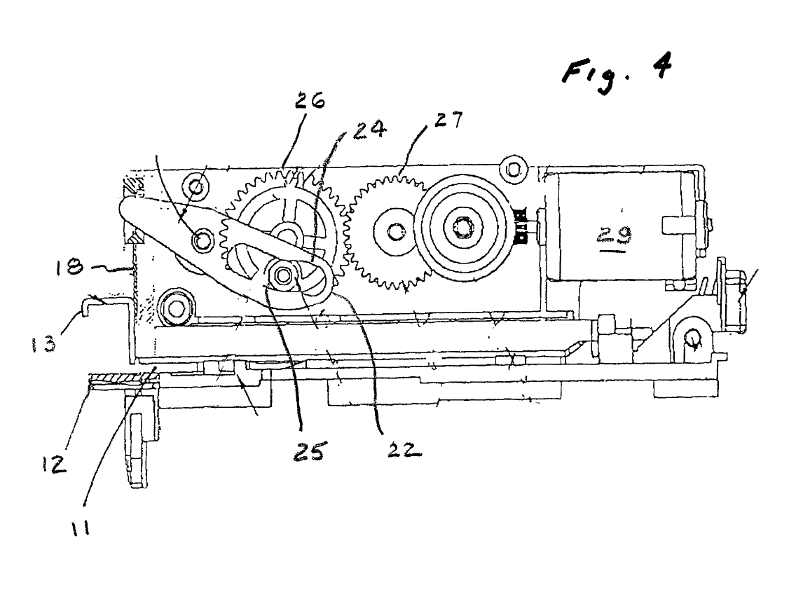

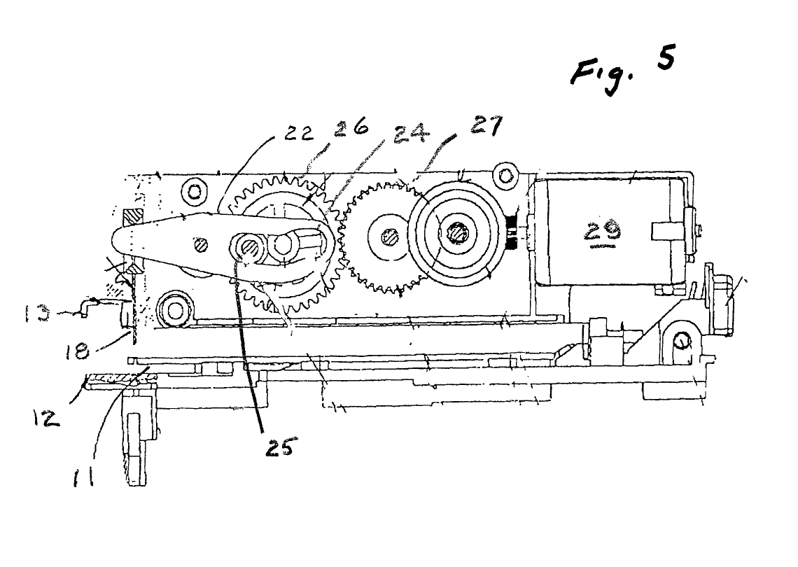

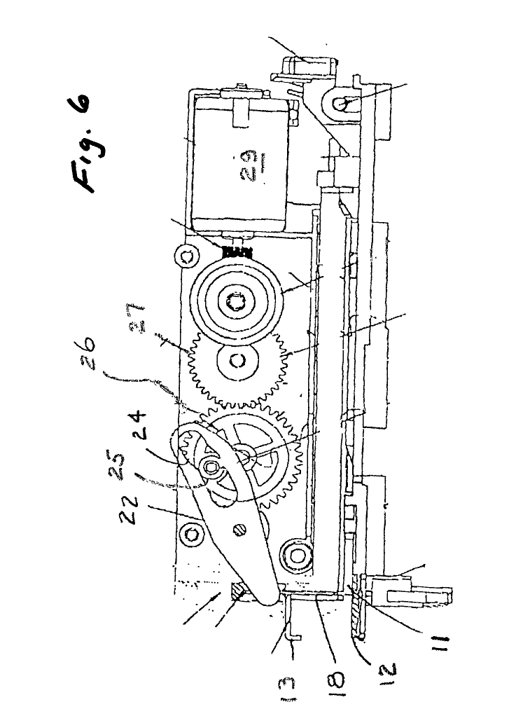

FIGS. 4, 5 and 6 show three sequential positions of the punch blade 18. In FIG. 4, the stapler is “at rest” with the punch blade 18 at its highest position. When sheets of paper are placed fully into the slot 11, the motor 29 is momentarily turned on and off to call as the gear 26 to rotate 360 degrees. FIGS. 4, 5, and 6 illustrate the respective positions of the lever 22 and the support 19 throughout approximately the first 175 degrees of movement. As illustrated by FIGS. 4, 5, and 6, the clockwise motion of the gear 26 and the crank 25 associated therewith that engages the slot 24 of the lever 22 causes pivotal movement the lever 22 to cause the punch blade 18 to move downwards. The punch blade 1 8 has a repetitious cyclical operation of any downstroke and an upstroke. FIG. 5 shows the punch blade 18 halfway down in the downstroke as the punch blade 1 8 moves towards the anvil 12. FIG. 6 shows the punch blade 18 at its lowest position during a stapling operation.

In the described embodiment, the gear 26 continues to turn clockwise, and although it has not quite completed a half of a revolution in FIG. 6, the punch blade 18 is not pushed any further down. This is because the slot 24 is non-uniformly disposed about a longitudinal axis. In other words, the slot 24 is asymmetrically disposed with respect to a longitudinal axis of the lever 22. Accordingly, the punch blade 18 is not moved at a uniform rate up and down even if the gear 26 has a constant rotational speed. Thus, the non-uniformity of the slot 24 causes the punch blade 18 to slow down or stop moving just before the gear 26 and the crank pin 25 reaches the upper most physically possible position.

The stapling cycle is completed when the gear 26 continues clockwise from the position shown in FIG. 6 to the position shown in FIG. 4, enabling the stapled-together sheets (not shown) to be readily withdrawn from the slot 11. Advantageously, the punch blade carrier 19 is constrained to move down vertically by the grooves 20. This movement is independent of the varying direction of forces applied by the end of the lever 22 acting on the inner edges of the aperture 21. In other words, only the vertical component of the force applied by the end of the lever 22 is utilized to move the punch blade carrier 19 within the slots 20. In at least some prior art structures isolation of the vertical force component is not achieved or is difficult to maintain. Because the vertical force component is not isolated, malfunctioning often occurs.

While a preferred embodiment has been set forth for describing the invention. The foregoing description should not be deemed a limitation of the invention herein. Accordingly, various modifications, adaptations and alternatives may occur to one skilled in the art without departing from the spirit and scope of the present invention.

What is claimed is:

1. A power stapler which comprises:
a housing;
a staple anvil supported by an internal side wall in said housing;
a staple carriage for feeding an associated cartridge of staples having a plurality of staples in aligned side-by-side relationship towards said staple anvil to position one of the staples in the cartridge above said staple anvil in position to be driven through a plurality of associated sheets held above said staple anvil;
a punch plate mounted for sliding movement substantially in a plane that is substantially perpendicular to said staple anvil;
an elongated intermediately pivoted lever having a first end disposed in meshing engagement with said punch plate whereby pivotal motion of said lever presses down and lifts up said punch plate to carry out stapling operations, said lever having a cam surface;
a gear mounted for rotation about axis thereof, said gear having a crank extending from a side thereof, said crank being disposed in meshing engagement with said cam surface to cause said lever to pivot upon rotation of said gear; and
an electric motor coupled to intermittently drive the gear through a series of discrete angular movements corresponding to each stapling operation.

2. A power stapler in accordance with claim 1, wherein said cam surface is an elongated closed channel within said lever that is dimensioned and configured to receive said crank whereby the crank slides backwards and forwards along the channel as the gear rotates to pivot said lever to cause said first end thereof to move up and down during each stapling operation.

3. A power stapler in accordance with claim 2, wherein said cam surface is dimensioned and configured to produce movement of said punch plate at varying rates of movement throughout the operating cycle of said punch plate with a constant rotational speed of said gear.

4. A power stapler in accordance with claim 3, wherein said cam surface achieves movement of said punch plate at varying rates of movement with a channel that is asymmetrically disposed with respect to said lever.

5. A power stapler in accordance with claim 1, further including a staple extractor tool mounted for sliding movement with respect to said housing and being dimensioned and configured to be manually moved and exposed at one end of said housing when required for use.

6. A power stapler in accordance with claim 2, further including a staple extractor tool mounted for sliding movement with respect to said housing and being dimensioned and configured to be manually moved and exposed at one end of said housing when required for use.

7. A power stapler in accordance with claim 3, further including a staple extractor tool mounted for sliding movement with respect to said housing and being dimensioned and configured to be manually moved and exposed at one end of said housing when required for use.

8. A power stapler in accordance with claimed 4, further including a staple extractor tool mounted for sliding movement with respect to said housing and being dimensioned and configured to be manually moved and exposed at one end of said housing when required for use.

9. A power stapler in accordance with claim 1, wherein said power stapler further includes a battery selectively coupled to said motor whereby said power stapler does not require connection to other sources of electrical power.

10. A power stapler in accordance with claim 2, wherein said power stapler further includes a battery selectively coupled to said motor whereby said power stapler does not require connection to other sources of electrical power.

11. A power stapler in accordance with claim 3, wherein said power stapler further includes a battery selectively coupled to said motor whereby said power stapler does not require connection to other sources of electrical power.

12. A power stapler in accordance with claim 4, wherein said power stapler further includes a battery selectively coupled to said motor whereby said power stapler does not require connection to other sources of electrical power.

13. A power stapler in accordance with claim 5, wherein said power stapler further includes a battery selectively coupled to said motor whereby said power stapler does not require connection to other sources of electrical power.

14. A power stapler in accordance with claim 6, wherein said power stapler further includes a battery selectively coupled to said motor whereby said power stapler does not require connection to other sources of electrical power.

15. A power stapler in accordance with claim 7, wherein said power stapler further includes a battery selectively coupled to said motor whereby said power stapler does not require connection to other sources of electrical power.

16. A power stapler in accordance with claim 8, wherein said power stapler further includes a battery selectively coupled to said motor whereby said power stapler does not require connection to other sources of electrical power.
